(19) United States
(12) Patent Application Publication
(10) Pub. No.: US 2019/0228227 A1
(43) Pub. Date: Jul. 25, 2019

(54) METHOD AND APPARATUS FOR EXTRACTING A USER ATTRIBUTE, AND ELECTRONIC DEVICE

(71) Applicant: BEIJING SENSETIME TECHNOLOGY DEVELOPMENT CO., LTD, Beijing (CN)

(72) Inventors: Fan ZHANG, Beijing (CN); Binxu PENG, Beijing (CN); Kaijia CHEN, Beijing (CN)

(73) Assignee: BEIJING SENSETIME TECHNOLOGY DEVELOPMENT CO., LTD, Beijing (CN)

(21) Appl. No.: 16/314,410

(22) PCT Filed: Dec. 26, 2017
(86) PCT No.: PCT/CN2017/118705

§ 371 Date: Dec. 29, 2018

(30) Foreign Application Priority Data
Dec. 28, 2016 (CN) 201611235485.8

(51) Int. Cl. G06K 9/00; G06F 16/9535; G06Q 30/02

(52) U.S. Cl. CPC G06K 9/00671; G06K 9/623; G06Q 30/0242; G06F 16/9535

(57) ABSTRACT

A method and an apparatus for extracting a user attribute, and an electronic device include: receiving image data sent by a second terminal; extracting user attribute information based on the image data; and determining a target service object corresponding to the user attribute information. Current biological images of the user are obtained in real time; it is easy and convenient; authenticity of the user attribute information may be ensured; the target service object is determined by means of the user attribute information, which is more in line with current demands of the user.

The present disclosure claims priority to Chinese Patent Application No. 201611235485.8 filed on Dec. 28, 2016 and entitled “METHOD AND APPARATUS FOR EXTRACTING A USER ATTRIBUTE, AND ELECTRONIC DEVICE,” the disclosure of which is hereby incorporated by reference in its entirety.

### TECHNICAL FIELD

Embodiments of the present disclosure relate to the data processing technologies, and in particular, to a method and an apparatus for extracting a user attribute, and an electronic device.

### BACKGROUND ART

Determining user attributes according to features of a user has important significance in the field of user researches, personalized recommendations, and accurate marketing.

### SUMMARY

Embodiments of the present disclosure provide a user attribute extracting solution.

According to an aspect of the embodiments of the present disclosure, a method for extracting a user attribute is provided, which is applied for a first terminal and includes: receiving image data sent by a second terminal; extracting user attribute information based on the image data; and determining a target service object corresponding to the user attribute information.

According to one or more embodiments of the present disclosure, in combination of any method for extracting a user attribute provided by the embodiments of the present disclosure, the image data includes video image data or static image data.

According to one or more embodiments of the present disclosure, in combination of any method for extracting a user attribute provided by the embodiments of the present disclosure, before the receiving the image data sent by a second terminal, the method further includes: sending an information obtaining request to the second terminal, to trigger the second terminal to send the image data; where the information obtaining request is configured to indicate the second terminal to collect the image data by means of an image collection device.

According to one or more embodiments of the present disclosure, in combination of any method for extracting a user attribute provided by the embodiment of the present disclosure, the sending an information obtaining request to the second terminal includes: sending the information obtaining request to the second terminal at intervals.

According to one or more embodiments of the present disclosure, in combination of any method for extracting provided by the embodiment of the present disclosure, the extracting user attribute information of a user based on the image data includes: taking a character with a highest appearing ratio among a plurality of characters as a target character when the image data includes the plurality of characters; and extracting the user attribute information corresponding to the target character.

According to one or more embodiments of the present disclosure, in combination of any method for extracting a user attribute provided by the embodiment of the present disclosure, the user attribute information at least includes any one or more of: age information, gender information, hair style information, preference information, facial expression information, and clothing information.

According to one or more embodiments of the present disclosure, in combination of any method for extracting a user attribute provided by the embodiment of the present disclosure, the method further includes: pushing the target service object to the second terminal.

According to another aspect of an embodiment of the present disclosure, an apparatus for extracting a user attribute is provided, which includes: a first receiving module, configured to receive image data sent by a second terminal; an extracting module, configured to extract user attribute information based on the image data; and a determining module, configured to determine a target service object corresponding to the user attribute information.

According to one or more embodiments of the present disclosure, in combination of any apparatus for extracting a user attribute provided by the embodiment of the present disclosure, the image data includes video image data or static image data.

According to one or more embodiments of the present disclosure, in combination of any apparatus for extracting a user attribute provided by the embodiment of the present disclosure, the apparatus further includes: a first sending module, configured to send an information obtaining request to the second terminal, to trigger the second terminal to send the image data; where the information obtaining request is configured to indicate the second terminal to collect the image data by means of an image collection device.

According to one or more embodiments of the present disclosure, in combination of any apparatus for extracting a user attribute provided by the embodiments of the present disclosure, the first sending module is configured to send the information obtaining request to the second terminal at intervals.

According to one or more embodiments of the present disclosure, in combination of any apparatus for extracting a user attribute provided by the embodiments of the present disclosure, the extracting module is configured to take a character with a highest appearing ratio among a plurality of characters as a target character when the image data includes the plurality of characters; and to extract the user attribute information corresponding to the target character.

According to one or more embodiments of the present disclosure, in combination of any apparatus for extracting a user attribute provided by the embodiments of the present disclosure, the user attribute information at least includes any one or more of: age information, gender information, hair style information, preference information, facial expression information, and clothing information.

According to one or more embodiments of the present disclosure, in combination of any apparatus for extracting a user attribute provided by the embodiments of the present disclosure, the apparatus further includes: a second sending module, configured to push the target service object to the second terminal.

According to another aspect of the embodiments of the present disclosure, another method for extracting a user attribute is provided, which includes: obtaining image data when receiving an information obtaining request sent by a first terminal;

and sending the image data to the first terminal so as to enable the first terminal to extract user attribute information based on the image data and determine a target service object corresponding to the user attribute information.

According to one or more embodiments of the present disclosure, in combination of any method for extracting a user attribute provided by the embodiments of the present disclosure, the image data includes video image data or static image data.

According to one or more embodiments of the present disclosure, in combination of any method for extracting a user attribute provided by the embodiments of the present disclosure, the obtaining image data when receiving an information obtaining request sent by a first terminal includes: collecting the image data when receiving the information obtaining request sent by the first terminal.

According to one or more embodiments of the present disclosure, in combination of any method for extracting a user attribute provided by the embodiments of the present disclosure, the collecting the image data by means of an image collection device when receiving the information obtaining request sent by the first terminal includes: displaying a start prompt message of the image collection device when receiving the information obtaining request sent by the first terminal; and collecting the image data by means of the image collection device when detecting a user confirmation instruction based on the start prompt message of the image collection device.

According to one or more embodiments of the present disclosure, in combination of any method for extracting a user attribute provided by the embodiments of the present disclosure, the image collection device includes: a camera of the second terminal or a smart device with a photographing function associated with the second terminal.

According to one or more embodiments of the present disclosure, in combination of any method for extracting a user attribute provided by the embodiments of the present disclosure, the method further includes: receiving a target service object pushed by the first terminal; and presenting the target service object.

According to a further aspect of the embodiments of the present disclosure, an apparatus for extracting a user attribute extracting is provided, which includes: an obtaining module, configured to obtain image data when receiving an information obtaining request sent by a first terminal; and a third sending module, configured to send the image data to the first terminal so as to enable the first terminal to extract user attribute information based on the image data and determine a target service object corresponding to the user attribute information. According to one or more embodiments of the present disclosure, in combination of any apparatus for extracting a user attribute provided by the embodiments of the present disclosure, the image data includes video image data or static image data.

According to one or more embodiments of the present disclosure, in combination of any apparatus for extracting a user attribute provided by the embodiments of the present disclosure, the obtaining module is configured to collect the image data by means of an image collection device when receiving the information obtaining request sent by the first terminal.

According to one or more embodiments of the present disclosure, in combination of any apparatus for extracting a user attribute provided by the embodiments of the present disclosure, the obtaining module includes: a display sub-module, configured to display a start prompt message of the image collection device when receiving the information obtaining request sent by the first terminal; and a collection sub-module, configured to collect the image data by means of the image collection device when detecting a user confirmation instruction based on the start prompt message of the image collection device.

According to one or more embodiments of the present disclosure, in combination of any apparatus for extracting a user attribute provided by the embodiments of the present disclosure, the image collection device includes: a camera of the second terminal or a smart device with a photographing function associated with the second terminal.

According to one or more embodiments of the present disclosure, in combination of any apparatus for extracting a user attribute provided by the embodiments of the present disclosure, the apparatus further includes: a second receiving module, configured to receive the target service object pushed by the first terminal; and a presenting module, configured to present the target service object.

According to a further aspect of the embodiments of the present disclosure, an electronic device is provided, which includes a processor and a memory; the memory is configured to store at least one executable instruction; the executable instruction enables the processor to execute the method for extracting a user attribute according to any of the embodiments of the present disclosure.

According to a further aspect of the embodiments of the present disclosure, another electronic device is provided, which includes a processor and the apparatus for extracting a user attribute according to any of the embodiments of the present disclosure; units in the apparatus for extracting a user attribute according to any of the embodiments of the present disclosure are run when the processor runs an operation apparatus of the service object.

According to a further aspect of the embodiments of the present disclosure, a computer program is provided, which includes computer readable codes; when the computer readable codes are run on a device, a processor in the device executes instructions for implementing steps in the method for extracting a user attribute according to any of the embodiments of the present disclosure.

According to a further aspect of an embodiment of the present disclosure, a computer readable storage medium, configured to store computer readable instructions, is provided; the instructions are executed, operations for implementing steps in the method for extracting a user attribute according to any of the embodiments of the present disclosure are implemented.

The user attribute extracting solution provided by the present embodiment relates to receiving image data sent by a second terminal, extracting user attribute information based on the image data, and determining a target service object corresponding to the user attribute information. Biological images of the user are obtained in real time; it is easy and convenient; authenticity of the user attribute information may be ensured; the target service object determined by means of the user attribute information is more in line with current demands of the user.

The technical solutions of the present disclosure are further described below in detail with the accompanying drawings and embodiments.

### DETAILED DESCRIPTION OF DRAWINGS

The accompanying drawings constituting a part of the specification describe embodiments of the present disclosure, and are intended to explain the principles of the present disclosure together with the description.

With reference to the accompanying drawings, according to the detailed description below, the present disclosure can be understood more clearly.

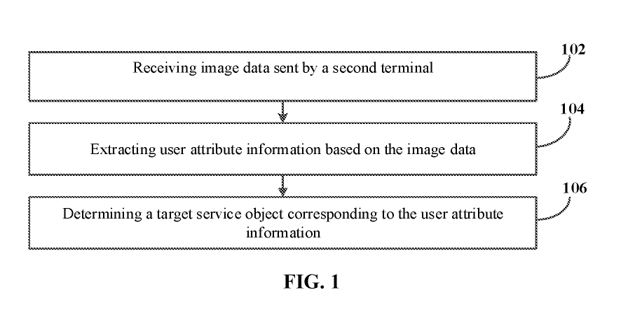

FIG. 1 is a flowchart of a method for extracting a user attribute according to an embodiment of the present disclosure;

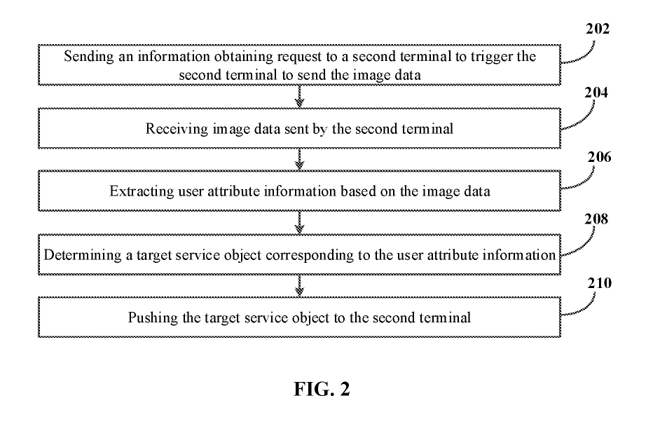

FIG. 2 is a flowchart of another method for extracting a user attribute according to an embodiment of the present disclosure;

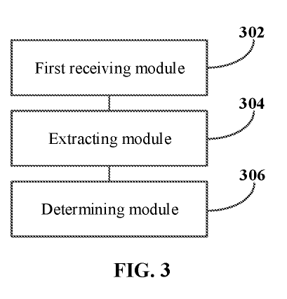

FIG. 3 is a structural block diagram of an apparatus for extracting a user attribute according to an embodiment of the present disclosure;

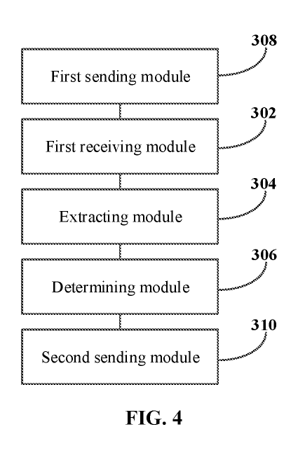

FIG. 4 is a structural block diagram of another apparatus for extracting a user attribute according to an embodiment of the present disclosure;

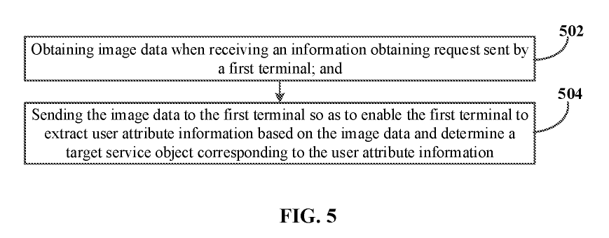

FIG. 5 is a flowchart of still another method for extracting a user attribute according to an embodiment of the present disclosure;

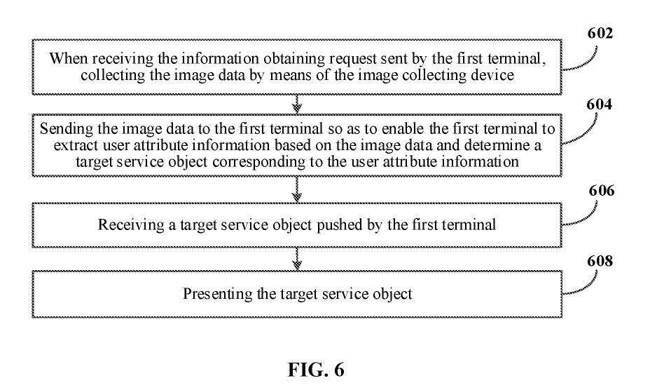

FIG. 6 is a flowchart of a further method for extracting a user attribute according to an embodiment of the present disclosure;

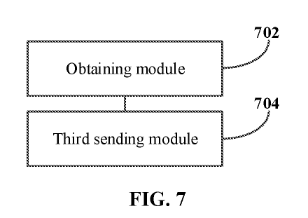

FIG. 7 is a structural block diagram of still another apparatus for extracting a user attribute according to an embodiment of the present disclosure;

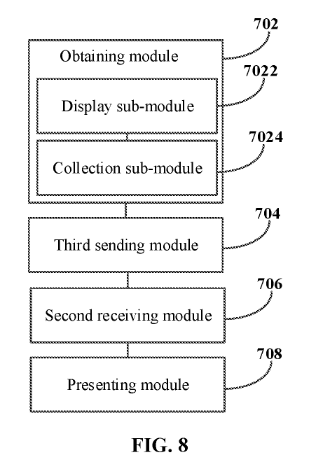

FIG. 8 is a structural block diagram of a further apparatus for extracting a user attribute according to an embodiment of the present disclosure; and

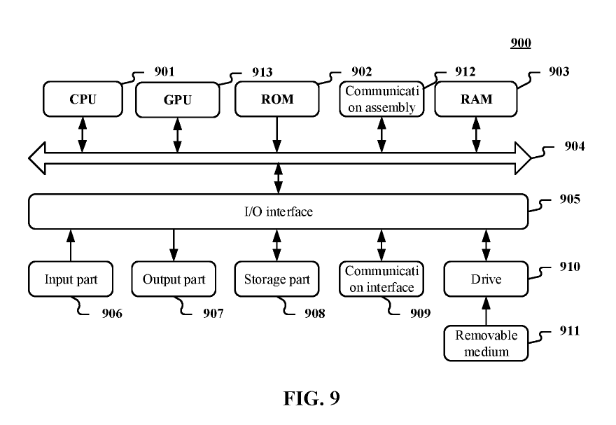

FIG. 9 is a schematic structural diagram of an electronic device according to an embodiment of the present disclosure.

### DETAILED DESCRIPTION

In combination of the accompanying drawings (same reference numerals in several drawings represent same elements) and embodiments, optional implementation modes of the embodiments of the present disclosure may be further explained in detail. The following embodiments are used for explaining the embodiments of the present disclosure, but are not intended to limit the scope of the embodiments of the present disclosure.

Persons skilled in the art may understand that terms “first”, “second”, etc. in the embodiments of the present disclosure are only used for distinguishing different steps, devices, or modules, and do not represent any special technical meanings, and likewise do not represent necessary logic orders therebetween.

It should be noted that: unless otherwise stated specifically, relative arrangement of the components and steps, the numerical expressions, and the values set forth in the embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and the applications or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

The embodiments of the present disclosure may be applied to electronic devices such as terminal devices, computer systems, servers, which may operate with numerous other general-purpose or special-purpose computing system environments or configurations. Examples of well-known computing systems, environments, and/or configurations suitable for use together with the computer systems/servers include, but are not limited to, personal computer systems, server computer systems, thin clients, thick clients, handheld or laptop devices, microprocessor-based systems, set top boxes, programmable consumer electronics, network personal computers, small computer systems, large computer systems, distributed cloud computing environments that include any one of the foregoing systems.

The electronic devices such as terminal devices, computer systems, and servers may be described in the general context of computer system executable instructions (for example, program modules) executed by the computer system. Generally, the program modules may include routines, programs, target programs, components, logics, and data structures, to execute specific tasks or implement specific abstract data types. The computer systems/servers may be practiced in the distributed cloud computing environments in which tasks are executed by remote processing devices that are linked through a communications network. In the distributed computing environments, program modules may be located in local or remote computing system storage medium including storage devices.

With reference to FIG. 1, a flowchart of a method for extracting a user attribute according to an embodiment of the present disclosure is shown. This embodiment is used for a first terminal. An anchor end in a live-broadcasting scene is taken as an example, so as to explain and illustrate the method for extracting a user attribute according to the embodiment of the present disclosure. The method for extracting a user attribute of this embodiment may include:

Step 102, image data sent by a second terminal is received.

In each embodiment of the present disclosure, to obtain attribute information of the user in real time, image data of the user is obtained to facilitate analysis of the image data to obtain the user attribute information of the user.

Each embodiment of the present disclosure may be applied in the live-broadcasting scene; a video communication connection is established between a first terminal (e.g., the anchor end) and a second terminal (e.g., a fan end) at a live-broadcasting room at a live-broadcasting platform where the anchor is located.

The first terminal receives the image data sent by the second terminal, where the image data may be sent by the second terminal actively and may also be image data that is returned by the second terminal upon receiving an information obtaining request of the first terminal. The image data may include, but not limited to, image data of the user of the second terminal.

In an optional example, step 102 may be executed by a processor by invoking corresponding instructions stored in a memory, and may also be executed by a first receiving module 302 run by the processor.

Step 104, user attribute information of a user is extracted based on the image data.

The first terminal performs character identification on the image data, to determine an image area corresponding to a character in the image, and then performs feature analysis on the image area according to a feature extracting algorithm to determine user attribute information corresponding to the user. In each embodiment of the present disclosure, the user attribute information may include, but not limited to, at least any one or more of: age information, gender information, hair style information, preference information, facial expression information, and clothing information.

The user attribute information of each embodiment of the present disclosure may be determined by adopting a human face detection algorithm or a neural network model, and other feature extracting algorithms may also be used. With this regard, the embodiments of the present disclosure do not make optional limitations.

In an optional example, step 104 may be executed by a processor by invoking corresponding instructions stored in a memory, and may also be executed by an extracting module 304 run by the processor.

Step 106, a target service object corresponding to the user attribute information is determined.

The first terminal determines the target service object corresponding thereto according to the user attribute information; the target service object relates to special effects including semantic information, for example, special effects including advertisement information in any one or more forms: a 2D sticker special effect, a 3D special effect, and a particle effect; for example, an advertisement presented in the form of a sticker (i.e., an advertisement sticker), or a special effect for presenting an advertisement, e.g., a 3D advertisement special effect; but it is not limited thereto; other forms of service objects are also adapted to a service counting solution provided in the embodiments of the present disclosure, for example, a literal explanation or introduction of an APP or other applications, or an object interacted with a video audience in a certain form (e.g., an electronic pet), etc.

In an optional example, step 106 may be executed by a processor by invoking corresponding instructions stored in a memory, and may also be executed by a determining module 306 run by the processor.

The method for extracting a user attribute provided by this embodiment includes: receiving the image data sent by the second terminal, extracting the user attribute information based on the image data, and determining the target service object corresponding to the user attribute information; biological images of the user may be obtained in real time; it is easy and convenient; authenticity of the user attribute information may also be ensured; the target service object determined by means of the user attribute information is more in line with current demands of the user. With reference to FIG. 2, a flowchart of another method for extracting a user attribute according to an embodiment of the present disclosure is shown; this embodiment is used for a first terminal and may include:

Step 202, an information obtaining request is sent to the second terminal to trigger the second terminal to send the image data.

The first terminal sends the information obtaining request to the second terminal; the second terminal obtains the image data of the user of the second terminal according to the information obtaining request; the information obtaining request may be in multiple forms, for example, a notification message, and for example, an interaction request attached to a game object.

For example, the anchor sends an interaction game request to fan users of multiple second terminals by means of the first terminal, and carries the information obtaining request in the interaction game request.

For example, during the live-broadcasting process, the anchor calls the fans to play an interaction game together and sends an interaction request of the interaction game to multiple fans. After the fans receive the interaction request, by triggering the interaction request, the interaction game would be presented at an interface of each fan end, meanwhile, a limit of authority of a camera of the fan end is obtained, and the image data of the fan is collected.

In an optional example, step 202 may be executed by a processor by invoking corresponding instructions stored in a memory, and may also be executed by a first sending module 308 run by the processor.

Step 204, image data sent by a second terminal is received.

The second terminal receives an information obtaining request sent by the first terminal, collects the image data of the user of the second terminal by means of an image collection device of the second terminal by means of determination on the information obtaining request made by the fan user of the second terminal, and sends the image data to the first terminal.

The image data in each embodiment of the present disclosure may include video image data or static image data, for example, a small video or picture.

In an optional example, step 204 may be executed by a processor by invoking corresponding instructions stored in a memory, and may also be executed by a first receiving module 302 run by the processor.

Step 206, user attribute information of a user is extracted based on the image data.

In each embodiment of the present disclosure, an identification (an ID number) of each second terminal device has a corresponding user; to enable the user attribute information to have more value, it is required to determine a target character corresponding to each second terminal ID, and perform user attribute information extraction on the image data of the target character.

For example, the information obtaining request is sent to the second terminal at intervals; multiple pieces of image data are obtained; character identification is performed on multiple pieces of image data; a character with a highest appearing ratio among the multiple pieces of image data (i.e., appearing for the maximum times) is determined as a target character; and the user attribute information of the target character is determined.

It should be explained that in this embodiment, the determined user attribute information is stored; the image data can be obtained at time intervals, and the user attribute information is extracted based on the obtained image data; the stored user attribute information is updated based on new user attribute information, i.e., updating the user attribute information according to time intervals.

In an optional solution of each embodiment of the present disclosure, the character with a highest appearing ratio among a plurality of characters as a target character when the obtained image data includes the plurality of characters, and the user attribute information of the target character is determined.

Based on the image data, whether a target character exists in the characters in the image data is determined; when it is determined that the target character exists in the characters in the image data, feature analysis is performed on the image area corresponding to the target character; the user attribute information of the target character is determined.

In an optional example, step 206 may be executed by a processor by invoking corresponding instructions stored in a memory, and may also be executed by an extracting module 304 run by the processor.

Step 208, a target service object corresponding to the user attribute information is determined.

In this embodiment, weighting calculation is performed on each information in the user attribute information; the weight of each information of the user attribute information can be set according to the attribute of the information, for example, a relatively small change exists in age information and gender information, and then a small weight can be set; moreover, a great change in the clothing information exists as the season changes, and then a great weight can be set; accordingly, the user attribute information is determined. For example, the weight of the age information is 10%, the weight of the gender information is 10%, the weight of the hair style information is 10%, the weight of preference information is 10%, the weight of the facial expression information is 20%, and the weight of the clothing information is 40%.

The target service object with an optimal matching degree with the user attribute information is determined, and can be determined using each attribute information in sequence.

The target service object in this embodiment is similar to that of the foregoing embodiments, and the details are not described herein again.

For example, an age period and gender of the user are determined according to the user attribute information; then personality of the user is determined according to the hair style information and facial expression information in the user attribute information; and finally, the clothing information of the user is determined according to the user attribute information. For example, it is determined that the user is a male at 15-18 years old; the personality of the user is optimistic; the clothing information shows that the clothes of the user are Nike Sportswear. Hence, it can be determined that the target service object to be pushed is sportswear of teen male Nike series.

In an optional example, step 208 may be executed by a processor by invoking corresponding instructions stored in a memory, and may also be executed by a determining module 306 run by the processor.

Step 201, the target service object is pushed to the second terminal.

The first terminal pushes the determined target service object to the second terminal; the second terminal, after receiving the target service object, may present same at a live-broadcasting interface of the second terminal.

In an optional example, step 210 may be executed by a processor by invoking corresponding instructions stored in a memory, and may also be executed by a second sending module 310 run by the processor. Application scenes in each embodiment of the present disclosure, in addition to live-broadcasting video interaction, may further include other forms of video interaction, for example, video calls in social software, and for example, WeChat videos, QQ videos, etc. With this regard, this embodiment does not make optional limitations.

The method for extracting a user attribute according to the embodiment of the present disclosure includes: sending the information obtaining request to the second terminal; receiving the image data sent by the second terminal; based on the image data, performing character identification on the image data; determining whether the character in the image data is a target character; if it is the target character, then extracting the user attribute information of the target character; then determining the target service object corresponding to the user attribute information; and pushing the target service object to the second terminal. The user attribute information is determined according to a biological image, which is easy and convenient as well as true and effective; the target service object determined by means of the user attribute information is more in line with the demands of the user, and achieves strategies of personalized recommendation and accurate marketing; obtaining the image data at intervals may further update the user attribute information on time to ensure validity of the information.

With reference to FIG. 3, a structural block diagram of an apparatus for extracting a user attribute according to an embodiment of the present disclosure is shown; the apparatus for extracting a user attribute of this embodiment may be used as the first terminal to execute the method for extracting a user attribute shown in FIG. 1. The apparatus for extracting a user attribute of this embodiment may include the following modules:

a first receiving module 302, configured to receive image data sent by a second terminal;

an extracting module 304, configured to extract user attribute information based on the image data; and

a determining module 306, configured to determine a target service object corresponding to the user attribute information.

The apparatus for extracting a user attribute provided by this embodiment includes: receiving the image data sent by the second terminal, extracting the user attribute information based on the image data, and determining the target service object corresponding to the user attribute information; biological images of the user may be obtained in real time; it is easy and convenient; authenticity of the user attribute information may also be ensured; the target service object determined by means of the user attribute information is more in line with current demands of the user.

With reference to FIG. 4, a structural block diagram of another apparatus for extracting a user attribute according to an embodiment of the present disclosure is shown; the apparatus for extracting a user attribute of this embodiment may be used as the first terminal to execute the method for extracting a user attribute shown in FIG. 2. The apparatus for extracting a user attribute of this embodiment may include the following modules:

The first sending module 308 is configured to send an information obtaining request to the second terminal, to trigger the second terminal to send the image data; where the information obtaining request is configured to indicate the second terminal to collect the image data by means of an image collection device.

According to one or more embodiments of the present disclosure, the first sending module 308 may further be configured to send the information obtaining request to the second terminal at intervals.

The image data may include, but not limited to, video image data or static image data.

The first receiving module 302 is configured to receive image data sent by a second terminal;

The extracting module 304 is configured to take a character with a highest appearing ratio among a plurality of characters as a target character when the image data includes the plurality of characters; and to extract the user attribute information corresponding to the target character.

The user attribute information may, for example, include, but not limited to, any one or more of age information, gender information, hair style information, preference information, facial expression information, and clothing information.

The determining module 306 is configured to determine a target service object corresponding to the user attribute information.

The second sending module 310 is configured to push the target service object to the second terminal.

The apparatus for extracting a user attribute of this embodiment includes: sending an information obtaining request to the second terminal; receiving the image data sent by the second terminal; performing the character identification on the image data based on the image data; determining whether the character in the image data is the target character; if it is the target character, then extracting the user attribute information of the target character; then determining the target service object corresponding to the user attribute information and pushing the target service object to the second terminal; and determining the user attribute information by means of biological images may be implemented; it is easy and convenient as well as true and effective; the target service object determined by means of the user attribute information is more in line with demands of the user, so as to implement and achieves strategies of personalized recommendation and accurate marketing; obtaining the image data at intervals may further update the user attribute information on time to ensure validity of the information.

With reference to FIG. 5, a flowchart of another method for extracting a user attribute according to an embodiment of the present disclosure is shown. This embodiment is used for a second terminal. A fan end in a live-broadcasting scene is taken as an example, so as to explain and illustrate the method for extracting a user attribute according to the embodiment of the present disclosure. The method for extracting a user attribute according to this embodiment may include:

Step 502, the image data is obtained when receiving an information obtaining request sent by the first terminal.

In the embodiment of the present disclosure, to obtain attribute information of the user in real time, image data of the user is obtained for analysis of the image data to obtain the user attribute information of the user.

Each embodiment of the present disclosure may be applied in the live-broadcasting scene; a video communication connection is established between a first terminal (e.g., the anchor end) and a second terminal (a fan end) at a live-broadcasting room at a live-broadcasting platform where the anchor is located.

When the second terminal receives the information obtaining request sent by the first terminal, the user of the second terminal determines the information obtaining request so as to enable the image collection device of the second terminal to obtain the image data of the user of the second terminal.

The image data therein may include video image data or static image data, for example, a small video or picture.

In an optional example, step 502 may be executed by a processor by invoking corresponding instructions stored in a memory, and may also be executed by an obtaining module 702 run by the processor.

Step 504, the image data is sent to the first terminal so as to enable the first terminal to extract user attribute information based on the image data and determine a target service object corresponding to the user attribute information.

After completing the image data collection, it is sent to the first terminal by the second terminal; after the first terminal receives the image data, the first terminal performs character identification on the image data to determine an image area corresponding to the character in the image, and then performs feature analysis on the area according to a feature extracting algorithm to determine the user attribute information corresponding to the user.

The user attribute information in each embodiment of the present disclosure may include, but not limited to, any one or more of age information, gender information, hair style information, preference information, facial expression information, and clothing information.

The user attribute information of this embodiment may be determined by adopting a human face detection algorithm or a neural network module, and other feature extracting algorithms may also be used. With this regard, the embodiments of the present disclosure do not make optional limitations.

The first terminal determines the target service object corresponding thereto according to the user attribute information; the target service object is special effects including semantic information, for example, special effects including advertisement information in at least one form of: a 2D sticker special effect, a 3D special effect, and a particle effect; for example, an advertisement presented in the form of a sticker (i.e., an advertisement sticker), or a special effect for presenting an advertisement, e.g., a 3D advertisement special effect; but it is not limited thereto; other forms of service objects are also adapted to a service counting solution provided in the embodiment of the present disclosure, for example, a literal explanation or introduction of an APP or other applications, or an object interacted with a video audience in a certain form (e.g., an electronic pet), etc.

In an optional example, step 504 may be executed by a processor by invoking corresponding instructions stored in a memory, and may also be executed by a third sending module 704 run by the processor.

The method for extracting a user attribute provided by this embodiment includes: obtaining the image data when receiving the information obtaining request sent by the first terminal, sending the image data to the first terminal, so as to enable the first terminal to extract the user attribute information based on the image data, and determine the target service object corresponding to the user attribute information; biological images of the user are obtained in real time by means of the information obtaining request, which is easy and convenient; meanwhile, authenticity of the user attribute information may further be ensured; the target service object determined by means of the user attribute information is more in line with the demands of the user.

With reference to FIG. 6, a flowchart of steps of a method for extracting a user attribute according to an embodiment of the present disclosure is shown; this embodiment is used for a second terminal and may include the following steps:

Step 602, when receiving the information obtaining request sent by the first terminal, the image data is collected by means of the image collection device.

When the second terminal receives the information obtaining request sent by the first terminal, by means of the triggering of the information obtaining request, the limit of authority of the image collection device of the second terminal is obtained and the image data of the user of the second terminal is collected by means of the image collection device. The information obtaining request may be in multiple forms, for example, a notification message, and for example, an interaction request attached to a game object.

For example, the anchor sends an interaction game request to fan users of multiple second terminals by means of the first terminal, and carries the information obtaining request in the interaction game request.

For example, when receiving the information obtaining request sent by the first terminal, a start prompt message of the image collection device is displayed; when a user confirmation instruction based on the start prompt message of the image collection device is detected, the image data is collected by means of the image collection device.

The image collection device of this embodiment may include a camera of the second terminal or a smart device having a photographing function associated with the second terminal.

For example, during the live-broadcasting process, the anchor calls the fans to play an interaction game together and sends an interaction request of the interaction game to multiple fans. After the fans receive the interaction request, the start prompt message of the image collection device is displayed at the interface of the fan end, by triggering the interaction request, i.e., a confirmation of the start prompt message of the image collection device, the interaction game would be presented at the interface of the fan end, meanwhile, a limit of authority of a camera of the fan end is obtained, and the image data of the fan is collected.

In an optional example, step 602 may be executed by a processor by invoking corresponding instructions stored in a memory, and may also be executed by an obtaining module 702 run by the processor.

Step 604, the image data is sent to the first terminal so as to enable the first terminal to extract user attribute information based on the image data and determine a target service object corresponding to the user attribute information. After completing the image data collection, it is sent to the first terminal by the second terminal; after the first terminal receives the image data, the first terminal performs character identification on the image data to determine an image area corresponding to the character in the image, and then performs feature analysis on the area according to a feature extracting algorithm to determine the user attribute information corresponding to the user.

The target service object with an optimal matching degree with the user attribute information is determined, and can be determined using each attribute information in sequence.

The target service object in this embodiment is similar to that of the embodiments, and is omitted herein.

For example, an age period and gender of the user is determined according to the user attribute information; then personality of the user is determined according to the hair style information and facial expression information in the user attribute information; and finally, the clothing information of the user is determined according to the user attribute information. For example, it is determined that the user is a male at 15-18 years old; the personality of the user is optimistic; the clothing information shows that the clothes of the user are Nike Sportswear. Hence, it can be determined that the target service object to be pushed is sportswear of teen male Nike series.

In an optional example, step 604 may be executed by a processor by invoking corresponding instructions stored in a memory, and may also be executed by a third sending module 704 run by the processor.

Step 606, the target service object pushed by the first terminal is received.

In an optional example, step 606 may be executed by a processor by invoking corresponding instructions stored in a memory, and may also be executed by a second receiving module 706 run by the processor.

Step 608, the target service object is presented.

The first terminal pushes the determined target service object to the second terminal; the second terminal, after receiving the target service object, may present same at a live-broadcasting interface of the second terminal.

In an optional example, step 608 may be executed by a processor by invoking corresponding instructions stored in a memory, and may also be executed by a presenting module 708 run by the processor.

Application scenes in each embodiment of the present disclosure, in addition to live-broadcasting video interaction, may further include other forms of video interaction, for example, video calls in social software, and for example, WeChat videos, QQ videos, etc. With this regard, this embodiment does not make optional limitations.

The method for extracting a user attribute provided by this embodiment includes: obtaining the image data when receiving the information obtaining request sent by the first terminal, sending the image data to the first terminal, so as to enable the first terminal to extract the user attribute information based on the image data, and determine the target service object corresponding to the user attribute information; biological images of the user are obtained in real time by means of the information obtaining request, which is easy and convenient; meanwhile, authenticity of the user attribute information may further be ensured; the target service object determined by means of the user attribute information is more in line with the demands of the user, and achieves strategies of personalized recommendation and accurate marketing; the fan may check the target service object meeting the requirements thereof while viewing live-broadcasting, so as to improve the user experience.

With reference to FIG. 7, a structural block diagram of another apparatus for extracting a user attribute according to an embodiment of the present disclosure is shown; the apparatus for extracting a user attribute of this embodiment may be used for the second terminal to execute the method for extracting a user attribute shown in FIG. 5. The apparatus for extracting a user attribute of this embodiment may include the following modules:

an obtaining module 702, configured to obtain image data when receiving an information obtaining request sent by a first terminal; and

a third sending module 704, configured to send the image data to the first terminal so as to enable the first terminal to extract user attribute information based on the image data and determine a target service object corresponding to the user attribute information.

The apparatus for extracting a user attribute provided by this embodiment includes: obtaining the image data when receiving the information obtaining request sent by the first terminal, sending the image data to the first terminal, so as to enable the first terminal to extract the user attribute information based on the image data, and determine the target service object corresponding to the user attribute information; biological images of the user are obtained in real time by means of the information obtaining request, which is easy and convenient; authenticity of the user attribute information may further be ensured; the target service object determined by means of the user attribute information is more in line with the demands of the user.

With reference to FIG. 8, a structural block diagram of an apparatus for extracting a user attribute according to Embodiment 9 of the present disclosure is shown; the apparatus for extracting a user attribute of this embodiment may be used for the second terminal to execute the method for extracting a user attribute shown in FIG. 6. The apparatus for extracting a user attribute of this embodiment may include the following modules:

an obtaining module 702, configured to collect the image data by means of the image collection device when receiving the information obtaining request sent by the first terminal.

As an improvement, the obtaining module 702 includes: a display sub-module 7022 and a collection sub-module 7024. The display sub-module 7022 is configured to display a start prompt message of the image collection device when receiving the information obtaining request sent by the first terminal; and

the collecting sub-module 7024 is configured to collect the image data by means of the image collection device when detecting a user confirmation instruction based on the start prompt message of the image collection device

The image data includes the video image data or static image data; the image collection device includes the camera of the second terminal, or the smart device having a photographing function associated with the second terminal.

The third sending module 704 is configured to send the image data to the first terminal so as to enable the first terminal to extract user attribute information based on the image data and determine a target service object corresponding to the user attribute information.

The second receiving module 706 is configured to receive the target service object pushed by the first terminal.

The presenting module 708 is configured to present the target service object.

The apparatus for extracting a user attribute provided by this embodiment includes: obtaining the image data when receiving the information obtaining request sent by the first terminal, sending the image data to the first terminal, so as to enable the first terminal to extract the user attribute information based on the image data, and determine the target service object corresponding to the user attribute information; biological images of the user are obtained in real time by means of the information obtaining request, which is easy and convenient; meanwhile, authenticity of the user attribute information may further be ensured; the target service object determined by means of the user attribute information is more in line with the demands of the user, and achieves strategies of personalized recommendation and accurate marketing; the fan may check the target service object meeting the requirements thereof while viewing live-broadcasting, so as to improve the user experience.

In addition, the embodiment of the present disclosure further provides an electronic device including a processor and a memory.

The memory is configured to store at least one executable instruction; the executable instruction enables the processor to execute the operation corresponding to the method for extracting a user attribute according to any of the embodiments of the present disclosure.

In addition, the embodiment of the present disclosure further provides another electronic device, including:

a processor and the apparatus for extracting a user attribute according to any of the embodiments of the present disclosure;

units in the apparatus for extracting a user attribute according to any of the embodiments of the present disclosure are run when the processor runs the apparatus for extracting a user attribute.

Embodiments of the present disclosure may further provide an electronic device, for example, a mobile terminal, a personal computer (PC), a tablet computer, a server, etc.

In addition, the embodiments of the present disclosure further provide a computer program, including computer readable codes; when the computer readable codes are run in a device, a processor in the device executes instructions for implementing each step in the method for extracting a user attribute according to any of the embodiments of the present disclosure.

In addition, the embodiments of the present disclosure further provide a computer readable storage medium, for storing computer readable instructions; when the instructions are executed, operations in each step in the method for extracting a user attribute according to any of the embodiments of the present disclosure are implemented. With reference to FIG. 9 as follows, a schematic structural diagram of an application embodiment of an electronic device 1000 adapted to implement the terminal device or server of the embodiments of the present disclosure. As shown in FIG. 9, the electronic device 900 includes one or more processors, communication components, etc.; the one or more processors, for example, are: one or more central processing units (CPU) 901, and/or one or more graph processing units (GPU) 903, etc.; the processor may execute various proper actions and processing according to the executable instructions stored in a read-only memory (ROM) 902 or executable instructions loaded into a random access memory (RAM) 903 from a storage part 908. The communication components include a communication assembly 912 and/or a communication interface 909. The communication assembly 912 may include, but not limited to, a network card; the network card may include, but not limited to, an IB (Infiniband) network card; the communication interface 909 includes communication interfaces of network interface cards such as a LAN card, a modem, etc.; communication processing is performed on the communication interface 909 by means of the network such as the Internet.

The processor may be communicated with the read-only memory 902 and/or random access memory 903 to execute the executable instructions, connected to the communication assembly 912 by means of a communication bus 904, and communicated with other target devices by means of the communication assembly 912, thereby implementing the operations corresponding to any method for extracting a user attribute provided by the embodiments of the present disclosure, for example, receiving the image data sent by the second terminal; extracting the user attribute information based on the image data; and determining the target service object corresponding to the user attribute information. For another example, when receiving the information obtaining request sent by the first terminal, the image data is obtained; the image data is sent to the first terminal so as to enable the first terminal to extract the user attribute information based on the image data, and the target service object corresponding to the user attribute information is determined.

Besides, in the ARM 903, each program and data required for apparatus operations may further be stored. The CPU 901 or GPU 913, the ROM 902, and the RAM 903 are connected to each other by means of the communication bus 904. In the presence of the RAM 903, the ROM 902 is an optional module. The executable instructions are stored in the RAM 903 or the executable instructions can be written into the ROM 902 during running; the executable instructions enable the processor 90 to execute the operations corresponding to the communication method. An input/output (I/O) interface 905 is also connected to the communication bus 904. The communication assembly 912 may be set integrally or may be set to have multiple sub-modules (for example, a plurality of IB network cards), and be on a communication bus link.

The following members are connected to the I/O interface 905: an input part 906 including a keyboard, a mouse, etc.; an output part 907 including, for example, a cathode-ray tube (CRT), a liquid crystal display (LCD), a loudspeaker, etc.; a storage part 908 including a hard disk; and a communication interface 909 of the network interface card including the LAN card, the modem, etc. A drive 910 is also connected to the I/O interface 905 according to requirements. A removable medium 911, such as a magnetic disk, a light disk, a magnetic light disk, a semiconductor memory, etc., is mounted on the drive 910 according to requirements, so as to be mounted into the storage part 908 from the computer program read therefrom according to requirements.

It should be explained that the frame shown in FIG. 9 is only an optional implementation mode; during an optional practicing process, the number and type of the members in FIG. 9 can be selected, deleted, added, or replaced according to actual requirements; in different functional part settings, implementing approaches such as separation settings or integration settings may also be used, for example, the GPU and the CPU may be separately set, or the GPU may be integrated on the CPU; the communication components may be separately set, or may also be set on the CPU or GPU, etc. The replaceable embodiments all fall into the scope of protection of the present disclosure.

In particular, the process described by the reference flowchart above may be implemented as a computer software program. For example, an embodiment of the present disclosure includes a computer program product. The computer program product includes a computer program tangibly included in a machine-readable medium. The computer program includes a program code for executing a method shown in the flowchart. The program code may include instructions for executing each corresponding step of the method according to the embodiment of the present disclosure, for example, when receiving the information obtaining request sent by the first terminal, obtaining the image data; sending the image data to the first terminal, so as to enable the first terminal to extract the user attribute information based on the image data and determine the target service object corresponding to the user attribute information. In such an embodiment, the computer program may be downloaded from the network by means of a communication component and installed, and/or installed from a removable medium 911. When executing the computer program by the processor, the functions above defined in the method of the embodiment of the present disclosure is executed.

The electronic device provided by this embodiment relates to: obtaining the image data when receiving the information obtaining request sent by the first terminal, sending the image data to the first terminal, so as to enable the first terminal to extract the user attribute information based on the image data, and determine the target service object corresponding to the user attribute information; biological images of the user are obtained in real time by means of the information obtaining request, which is easy and convenient; meanwhile, authenticity of the user attribute information may further be ensured; the target service object determined by means of the user attribute information is more in line with the demands of the user.

Any method for extracting a user attribute provided by the embodiments of the present disclosure may be executed by any proper device having a data processing capacity, including, but not limited to: a terminal device and a server. Or any method for extracting a user attribute provided by the embodiments of the present disclosure may be executed by the processor, for example, any method for extracting a user attribute mentioned in the embodiments of the present disclosure is executed by the processor by invoking corresponding instructions stored in the memory. The details are not described below.

Persons of ordinary skill in the art may understand: all or some steps of the method embodiment above may be completed by means of hardware related to program instructions; the preceding programs may be stored in a computer readable storage medium; the programs execute the steps of the method embodiment above during execution of the programs; moreover, the preceding storage medium includes: various medium that may store program codes, such as ROM, RAM, magnetic disks, or light disks. The embodiments of the present description are all described in a progressive manner, and each embodiment focuses on illustrating differences from one another. Mutual references may be made to the same or similar portions among these embodiments. Apparatus and device embodiments basically correspond to method embodiments, and therefore are described relatively simply. For related parts, reference may be made to related descriptions of the method embodiments.

The methods, apparatuses, and devices of the present disclosure may be implemented by many manners. For example, the methods, apparatuses, and devices of the present disclosure may be implemented by software, hardware, firmware, or any combination thereof. Unless otherwise specially stated, the foregoing sequences of steps of the methods are merely for description, and are not intended to limit the steps of the methods of the present disclosure. In addition, in some embodiments, the present disclosure may be implemented as programs recorded in a recording medium. The programs include machine-readable instructions for implementing the methods according to the present disclosure. Hence, the present disclosure further covers the recording medium storing programs for executing the method of the embodiment of the present disclosure.

The description of the embodiments of the present disclosure is given for illustration and description, and not intended to be exhaustive or limit the present disclosure to the disclosed form; many amendments and changes are obvious to persons of ordinary skill in the art. The embodiments are selected and described to better describe a principle and an actual application of the present disclosure, and to make persons of ordinary skill in the art understand the present disclosure, so as to design various embodiments with various modifications applicable to particular use.

1. A method for extracting a user attribute, the method comprising:
obtaining, by a second terminal, image data when receiving an information obtaining request sent by a first terminal;
sending, by the second terminal, the image data to the first terminal;
receiving, by the first terminal, the image data sent by the second terminal;
extracting, by the first terminal, user attribute information based on the image data; and
determining, by the first terminal, a target service object corresponding to the user attribute information.

2. The method according to claim 1, wherein the image data comprises video image data or static image data.

3. The method according to claim 1, wherein before the step of receiving, by the first terminal, the image data sent by the second terminal, the method further comprises:
sending, by the first terminal, an information obtaining request to the second terminal, to trigger the second terminal to send the image data; wherein the information obtaining request is configured to indicate the second terminal to collect the image data by using an image collection device.

4. The method according to claim 3, wherein the step of sending the information obtaining request to the second terminal comprises:
sending, by the first terminal, the information obtaining request to the second terminal at intervals.

5. The method according to claim 1, wherein the step of extracting, by the first terminal, the user attribute information based on the image data comprises:
taking, by the first terminal, a character with a highest appearing ratio among a plurality of characters as a target character when the image data comprises the plurality of characters; and
extracting, by the first terminal, the user attribute information corresponding to the target character.

6. The method according to claim 1, wherein the user attribute information comprises at least one of: age information, gender information, hair style information, preference information, facial expression information, or clothing information.

7. The method according to claim 1, further comprising:
pushing, by the first terminal, the target service object to the second terminal.

8.-9 (canceled)

10. The method according to claim 1, wherein the step of obtaining, by the second terminal, the image data when receiving the information obtaining request sent by the first terminal comprises:
collecting, by the second terminal, the image data by using an image collection device when receiving the information obtaining request sent by the first terminal, wherein the image collection device comprises: a camera of the second terminal or a smart device with a photographing function associated with the second terminal.

11. The method according to claim 10, wherein the step of collecting, by the second terminal, the image data by using the image collection device when receiving the information obtaining request sent by the first terminal comprises:
displaying, by the second terminal, a start prompt message of the image collection device when receiving the information obtaining request sent by the first terminal; and
collecting, by the second terminal, the image data by using the image collection device when detecting a user confirmation instruction based on the start prompt message of the image collection device.

12. (canceled)

13. The method according to claim 8, further comprising:
receiving, by the second terminal, the target service object pushed by the first terminal; and
presenting, by the second terminal, the target service object.

14. first terminal for extracting a user attribute, the first terminal comprising:
a processor; and
memory having stored therein instructions;
wherein execution of the instructions by the processor causes the processor to perform operations including:
receiving image data sent by a second terminal;
extracting user attribute information based on the image data; and
determining a target service object corresponding to the user attribute information.

15. The first terminal according to claim 14, wherein the image data comprises video image data or static image data.

16. The first terminal according to claim 14, wherein the operations further comprise:
sending an information obtaining request to the second terminal, to trigger the second terminal to send the image data; wherein the information obtaining request is configured to indicate the second terminal to collect the image data by using an image collection device.

17. The first terminal according to claim 16, wherein the operation of sending the information obtaining request to the second terminal comprises: sending the information obtaining request to the second terminal at intervals.

18. The first terminal according to claim 14, wherein the operation of extracting the user attribute based on the image data comprises:
taking a character with a highest appearing ratio among a plurality of characters as a target character when the image data comprises the plurality of characters; and
extracting the user attribute information corresponding to the target character.

19. (canceled)

20. The first terminal according to claim 14, wherein the operations further comprise:
pushing the target service object to the second terminal.

21. A second terminal for extracting a user attribute, the second terminal comprising:
a processor; and
a memory having stored therein instructions;
wherein execution of the instructions by the processor causes the processor to perform operations, the operations comprising:
obtaining image data when receiving an information obtaining request sent by a first terminal; and
sending the image data to the first terminal so as to enable the first terminal to extract user attribute information based on the image data and determine a target service object corresponding to the user attribute information.

22. (canceled)

23. The second terminal according to claim 21, wherein the operation of obtaining the image data when receiving the information obtaining request sent by the first terminal comprises:
collecting the image data by using an image collection device when receiving the information obtaining request sent by the first terminal, wherein the image collection device comprises: a camera of the second terminal or a smart device with a photographing function associated with the second terminal.

24. The second terminal according to claim 23, wherein the operation of collecting the image data by using the image collection device when receiving the information obtaining request sent by the first terminal comprises:
displaying a start prompt message of the image collection device when receiving the information obtaining request sent by the first terminal; and
collecting the image data by using the image collection device when detecting a user confirmation instruction based on the start prompt message of the image collection device.

25. (canceled)

26. The second terminal according to claim 21, the operations further comprise:
receiving the target service object pushed by the first terminal; and
presenting the target service object.

27.-30. (canceled)
